(19) United States
(12) Patent Application Publication
(10) Pub. No.: US 2019/0365088 A1
(43) Pub. Date: Dec. 5, 2019

(54) MULTIFUNCTIONAL LIFTING TABLE

(71) Applicant: Zhejiang Yotrio Group Co., Ltd., Linhai City (CN)

(72) Inventors: Xiaozhou Shan, Linhai City (CN); Jianqiang Xie, Linhai City (CN)

(73) Assignee: Zhejiang Yotrio Group Co., Ltd., Linhai City (CN)

(21) Appl. No.: 16/399,127

(22) Filed: Apr. 30, 2019

(30) Foreign Application Priority Data
May 31, 2018 (CN) 201820839812.9

(51) Int. Cl. A47B 9/16; A47B 37/04; H02S 20/20; H02S 40/38

(52) U.S. Cl. CPC A47B 9/16; A47B 37/04; H02S 20/20; H02J 7/355; A47B 2200/008; A47B 2200/0056; H02S 40/38

(57) ABSTRACT

This invention provides a multifunctional lifting table, and the multifunctional lifting table includes a tabletop, an outer frame, an inner frame, and a lifting mechanism. The tabletop includes a tabletop main body and a solar panel, and the solar panel is embedded into the tabletop main body. The solar panel has at least one output interface, and the output interface is located at one side of the tabletop main body. The inner frame supports the tabletop, the outer frame has a containing space therein, and the inner frame is embedded into the containing space of the outer frame. The lifting mechanism is connected with the inner frame and the outer frame, and the lifting mechanism drives the inner frame to rise from the outer frame or to lower the inner frame and allow the inner frame to be hidden inside the outer frame.

### CROSS-REFERENCE TO RELATED APPLICATIONS

This Non-provisional application claims priority under 35 U.S.C. § 119(a) on Chinese Patent Application No(s). 201820839812.9 filed on May 31, 2018, the entire contents of which are hereby incorporated by reference.

### BACKGROUND OF THE INVENTION

### Field of the Invention

This invention relates to a lifting table, and more particularly, to a multifunctional lifting table suitable for outdoor use.

### Description of the Related Art

In life, people use furniture such as a table, and the table used by a family generally has a relatively single function, such as being used for dining, goods placing, talks, tea drinking and so on. Tables with various kinds of appearances on the market, including tables for outdoor and indoor use, are almost the same. However, with development of society, people's leisure and entertainment way has been different from the traditional way. Modern people have rich leisure and entertainment methods, and tables with single function gradually cannot meet diverse needs of people's life. For example, when people use a dining table or a tea table in outdoor leisure time, they often cannot do without electronic equipment, such as a mobile phone. However, ordinary electronic equipment has a faster power consumption, and the outdoor dining table or the tea table cannot provide convenient charging. For another example, an ordinary dining table or tea table is fixed in structure and cannot be switched in various applications. The height of the dining table is relatively high, and it is inconvenient to use for a tea conversation. Therefore, it is not possible to achieve one table with multiple functions. Although the structures and appearances of the tables are constantly improved and updated, and various kinds of tables are derived in the market in recent years, there is still no novel and original design.

### BRIEF SUMMARY OF THE INVENTION

One objective of this invention is to provide a multifunctional lifting table, which solves the problem that the existing table only has a single function.

To solve the above-mentioned problem, this invention provides a multifunctional lifting table, and the multifunctional lifting table includes a tabletop, an outer frame, an inner frame and a lifting mechanism. The tabletop includes a tabletop main body and a solar panel, and the solar panel is embedded into the tabletop main body. The solar panel has at least one output interface, and the output interface is located at one side of the tabletop main body. The inner frame supports the tabletop, the outer frame has a containing space therein, and the inner frame is embedded into the containing space of the outer frame. The lifting mechanism includes a first fixing frame, a second fixing frame, a first movable frame, a second movable frame and a motor. Outer edges of the first fixing frame are fixed at inner walls of the inner frame, and opposite two sides of the first fixing frame are provided with a sliding groove, respectively. Outer edges of the second fixing frame are fixed at inner walls of the outer frame, opposite two sides of the second fixing frame are provided with a sliding groove, respectively, and the two sliding grooves of the second fixing frame are correspondingly parallel to the two sliding grooves of the first fixing frame, respectively. One side of the first movable frame is pivotally connected with the first fixing frame, and the other side of the first movable frame is slidingly connected with the sliding groove of the second fixing frame, such that the first movable frame is obliquely disposed between the first fixing frame and the second fixing frame. One side of the second movable frame is pivotally connected with the second fixing frame, and the other side of the second movable frame is connected with the sliding groove of the first fixing frame, such that the second movable frame is obliquely disposed between the first fixing frame and the second fixing frame, two sides of the first movable frame are pivotally connected with two sides of the second movable frame, respectively, and one side of the second movable frame has a pushing rod. One end of the motor is connected with the second fixing frame, the other end of the motor is connected with the pushing rod of the second movable frame, and the motor pushes the pushing rod of the second movable frame, such that the second movable frame slides along the sliding grooves of the first fixing frame, and the first movable frame synchronously slides along the sliding grooves of the second fixing frame, such that the inner frame is driven to be lifted from the outer frame, or the inner frame is lowered to be hidden in the outer frame.

According to one embodiment of this invention, the tabletop main body may be formed by weaving and winding rattan around pipes.

According to one embodiment of this invention, the solar panel may be a tempered solar glass panel, and a thickness of the solar panel may be 5 mm

According to one embodiment of this invention, the inner frame may be formed by weaving and winding rattan around pipes.

According to one embodiment of this invention, the outer frame may be formed by weaving and winding rattan around pipes.

According to one embodiment of this invention, the multifunctional lifting table may include a control panel and a battery box, and the control panel may be disposed at one side of the tabletop main body. The control panel may have a key, and the battery box may include a battery and a controller. The control panel may be electrically connected with the controller, the controller may be electrically connected with the battery, and the controller may be electrically connected with the lifting mechanism.

According to one embodiment of this invention, the solar panel may be electrically connected with the controller so as to supply power to the lifting mechanism.

According to one embodiment of this invention, the multifunctional lifting table may include a remote control, and the remote control may remotely control the lifting mechanism.

According to one embodiment of this invention, shapes of the tabletop, the inner frame, and the outer frame are selected from the group consisting of a square shape, a circular shape and a ship shape.

Compared with the prior art, this technical solution has the following advantages.

In this invention, by embedding the inner frame into the interior of the outer frame and driving the inner frame to be lifted or lowered from the outer frame through the lifting mechanism, when the inner frame is lifted, the tabletop is lifted along with the inner frame, the height of the whole multifunctional lifting table increases, and at this time the multifunctional lifting table can be used as the dining table; on the contrary, when the height of the inner frame decreases, the inner frame can be hidden in the interior of the outer frame, the height of the whole multifunctional lifting table decreases, and at this time the multifunctional lifting table can be used as the tea table. In other words, the multifunctional lifting table provided by this invention is a table integrating a variety of functions for example being used as the dining table and the tea table. In this invention, by embedding the solar panel into the tabletop main body, the tabletop has a solar power generation function, and the solar panel can charge a user's electronic product such as a mobile phone, a tablet computer and so on through the output interface. The multifunctional lifting table is very suitable for outdoor leisure and entertainment. It is a table integrating dining, tea drinking, talks, entertainment, power supply and other functions.

### BRIEF DESCRIPTION OF THE DRAWINGS

FIG. 1 is a three-dimensional structure diagram of a multifunctional lifting table provided by this invention in a lowered state, wherein an inner frame of the multifunctional lifting table is lowered and hidden in an outer frame;

FIG. 2 is a bottom view of the multifunctional lifting table provided by this invention in the lowered state;

FIG. 3 is a three-dimensional structure diagram of the multifunctional lifting table provided by this invention in a lifted state, wherein the inner frame of the multifunctional lifting table is lifted from the outer frame;

FIG. 4 is an inverted three-dimensional structure diagram of the multifunctional lifting table provided by this invention in the lifted state;

FIG. 5 is a side view of the multifunctional lifting table provided by this invention in the lifted state, showing a structure of a lifting mechanism;

FIG. 6 is a side view of the multifunctional lifting table provided by this invention in the lifted state from another visual angle;

FIG. 7 is a side view of the multifunctional lifting table provided by this invention in the lowered state; and

FIG. 8 is a side view of the multifunctional lifting table provided by this invention in the lowered state from another visual angle.

### DETAILED DESCRIPTION OF THE INVENTION

The following description is only used to expose the present invention so that those skilled in the art can implement the present invention. The following described embodiments are only examples, and those skilled in the art can think of other obvious modifications. The basic principle of the present invention defined in the following description can be applied to other embodiments, variants, improvements, equivalents and other solutions without departing from the spirit and scope of the present invention.

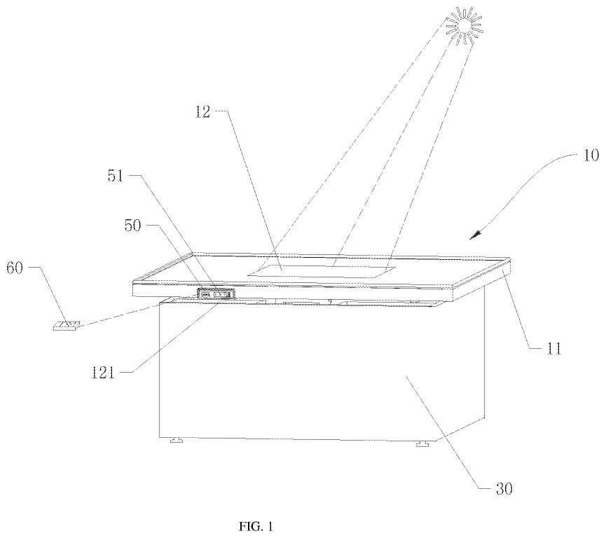

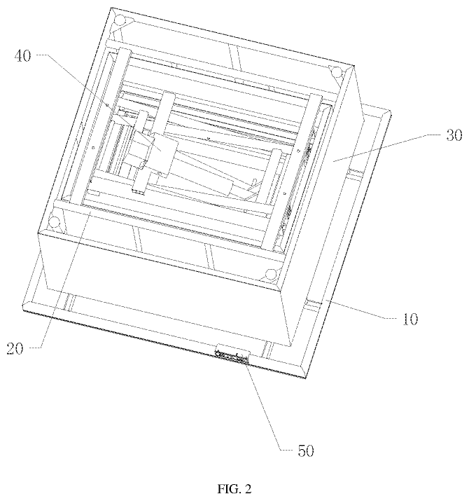

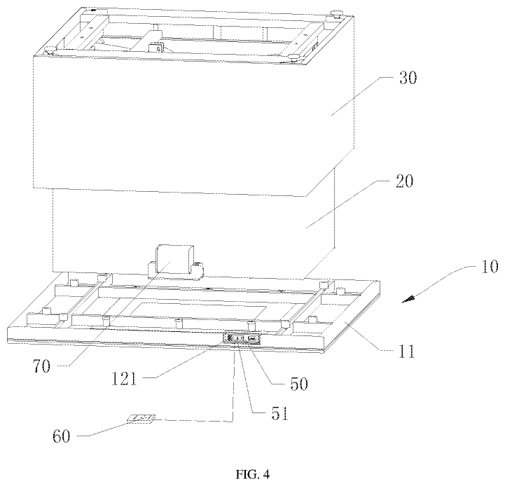

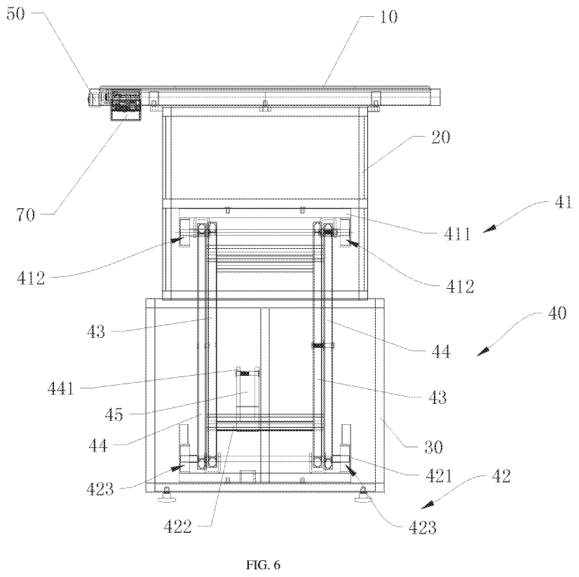

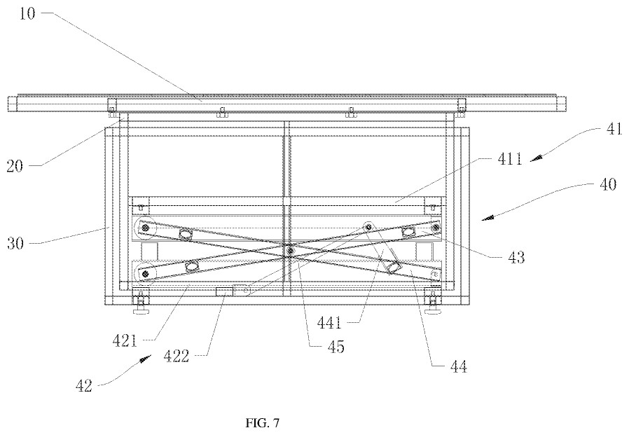

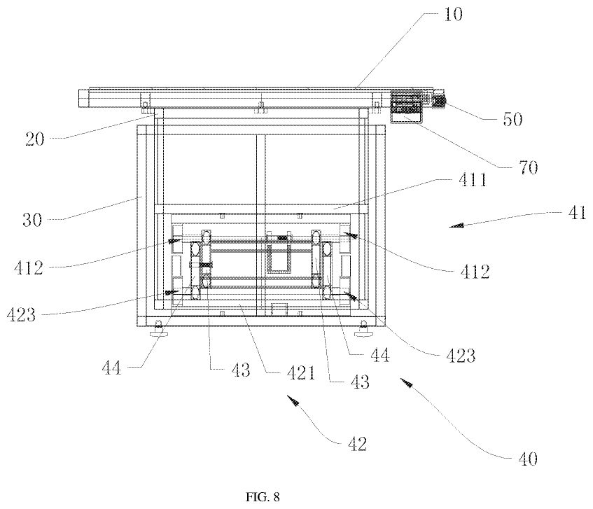

As shown from FIG. 1 to FIG. 8, this invention provides a multifunctional lifting table, especially a multifunctional lifting table suitable for outdoor leisure and entertainment, and the multifunctional lifting table can use solar to supply power to a user. The multifunctional lifting table includes a tabletop 10, an inner frame 20, an outer frame 30 and a lifting mechanism 40.

The tabletop 10 is square, and the tabletop 10 includes a tabletop main body 11 and a solar panel 12. Optionally, in other embodiments, the tabletop 10 is round or ship shaped. That is to way, the shape of the tabletop 10 is selected from one of a square shape, a circular shape, and a ship shape.

The tabletop main body 11 is formed by weaving and winding rattan around pipes. Specifically, the tabletop main body 11 includes a frame formed by connecting pipes and rattan, and rattan is weaved and wound around the frame.

Optionally, in another embodiment, the tabletop main body 11 is formed by weaving and winding rattan around battens, that is to say, the tabletop main body 11 includes a frame formed by connecting battens and rattan, and rattan is weaved and wound around the frame. Optionally, in another embodiment, the tabletop 11 is made of glass.

The solar panel 12 can use solar to supply power, optionally, the thickness of the solar panel 12 is 5 mm Optionally, the solar panel 12 is tempered solar glass panel. The solar panel 12 is embedded into the tabletop main body 11. As shown in FIG. 1, the solar panel 12 is embedded into the center of the tabletop main body 11, and the solar panel 12 and the tabletop main body 11 form a plane. That is to say, the solar panel 12 and the tabletop main body 11 form the tabletop 10 and form a plane of the tabletop to place goods. The solar panel 12 has at least one output interface 121, and the output interface 121 is located at one side of the tabletop main body 11. The solar panel 12 receives sun's rays and generates electricity. The solar panel 12 outputs power through the output interface 121 so as to supply power to the user.

Optionally, the number of the output interface 121 is four. Optionally, the output interface 121 is a USB interface. However, the present invention is not limited thereto. In other embodiments, the number of the output interface 121 is other values, such as two; and the output interface 121 is another type of interface.

The inner frame 20 is square, and the inner frame 20 supports the tabletop 10. The inner frame 20 contacts the bottom of the tabletop 10 to support the tabletop 10. The inner frame 20 is formed by weaving and winding rattan around pipes. Specifically, the inner frame 20 includes a frame formed by connecting pipes and rattan, and rattan is weaved and wound around the frame.

Optionally, in other embodiments, the inner frame 20 is round or ship shaped. That is to way, the shape of the inner frame 20 is selected from one of a square shape, a circular shape, and a ship shape.

The outer frame 30 is square, and the outer frame 30 is formed by weaving and winding rattan around pipes. Specifically, the outer frame 20 includes a frame formed by connecting pipes and rattan, and rattan is weaved and wound around the frame. The outer frame 30 has a containing space inside, and the inner frame 20 is embedded at the containing space of the outer frame 30, that is, the inner frame 20 is located in the outer frame 30, and the outer frame 30 surrounds the inner frame 20. The inner frame 20 is operatively lifted or lowered from the outer frame 30.

Optionally, in other embodiments, the outer frame 30 is round or ship shaped. That is to way, the shape of the outer frame 30 is selected from one of a square shape, a circular shape, and a ship shape.

It should be noted that the shapes of the tabletop 10, the inner frame 20, and the outer frame 30 match with each other. For example, when the tabletop 10 is round, the shapes of the inner frame 20 and the outer frame 30 are correspondingly round. Thus, the multifunctional lifting table is a round table.

The lifting mechanism 40 is connected with the inner frame 20 and the outer frame 30, that is to say, the inner frame 20 and the outer frame 30 are connected into a whole through the lifting mechanism 40. The lifting mechanism 40 is placed in the inner frame 20, that is, under a usage state, the lifting mechanism 40 is located below the tabletop 10 and is hidden in the interior of the whole multifunctional lifting table. The lifting mechanism 40 drives the inner frame 20 to be lifted from the outer frame 30, or makes the inner frame 20 be lowered and hidden in the outer frame 30. When the lifting mechanism 40 drives the inner frame 20 to be lifted from the outer frame 30, the height of the whole multifunctional lifting table increases, at this time the multifunctional lifting table can be used as the dining table, a writing table and so on. When the lifting mechanism 40 drives the inner frame 20 to be lowered and the inner frame 20 is hidden in the outer frame 30, the height of the whole multifunctional lifting table decreases, at this time the multifunctional lifting table can be used as the tea table, a coffee table, a meeting table and so on. By controlling up and down of the inner frame 20 through the lifting mechanism 40 to control the height of the multifunctional lifting table, the multifunctional lifting table can be used as the dining table, the writing table, the tea table, the coffee table, the meeting table and so on, which achieve one table with multifunction.

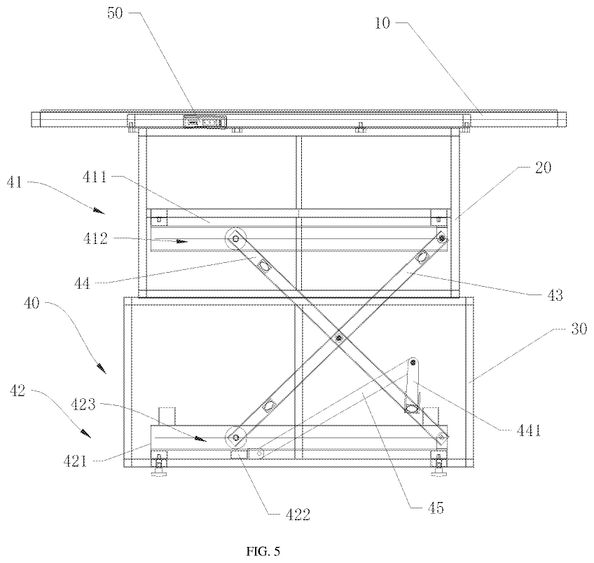

Specifically, as shown in FIG. 5 to FIG. 8, the lifting mechanism 40 includes a first fixing frame 41, a second fixing frame 42, a first movable frame 43, a second movable frame 44 and a motor 45. Outer edges of the first fixing frame 41 are fixed at inner walls of the inner frame 20. The shape of the first fixing frame 41 matches with the shape of the inner frame 20, the first fixing frame 41 is a square frame, and the first fixing frame 41 has four edges. Optionally, in other embodiments, if the inner frame 20 is round or ship shaped, the first fixing frame 41 is correspondingly round or ship shaped. Opposite sides of the first fixing frame 41 have a sliding groove 412, respectively, that is, the first fixing frame 41 has two sliding grooves 412.

Outer edges of the second fixing frame 42 are fixed at inner walls of the outer frame 30, and the second fixing frame 42 is located at the bottom of the outer frame 30 and is parallel to the first fixing frame 41. The shape of the second fixing frame 42 matches with the outer frame 30, the second fixing frame 42 is a square frame, and the second fixing frame 42 has four edges 421 and one fixing rod 422. The four edges 421 are connected end to end to form a rectangle, and two ends of the fixing rod 422 are connected with the opposite two edges 421, respectively. Optionally, in other embodiments, if the outer frame is round or ship shaped, the second fixing frame 42 is correspondingly round or ship shaped. Under the usage state, the first fixing frame 41 is located above the second fixing frame 42. Opposite sides of the second fixing frame 42 have a sliding groove 423, respectively, that is, the second fixing frame 42 has two sliding grooves 423. Two sliding grooves 423 of the second fixing frame 42 are correspondingly parallel to the two sliding grooves 412 of the first fixing frame 41. In other words, one of the sliding grooves 412 of the first fixing frame 41 is located at the same side of one of the sliding grooves 423 of the second fixing frame 42; and the other sliding groove 412 of the first fixing frame 41 is located at the same side of the other sliding groove 423 of the second fixing frame 42.

The first movable frame 43 is a square frame, and the first movable frame 43 has four edges. One side of the first movable frame 43 is pivotally connected with the first fixing frame 41, and the other side of the first movable frame 43 is slidably connected with the sliding groove 421 of the second fixing frame 42, such that the first movable frame 43 is obliquely located between the first fixing frame 41 and the second fixing frame 43, and the first movable frame 43 slides along the second fixing frame 42.

The second movable frame 44 is a square frame, and the second movable frame 44 has four edges. One side of the second movable frame 44 is pivotally connected with the second fixing frame 42, and the other side of the second movable frame 44 is slidably connected with the sliding groove 411 of the first fixing frame 41, such that the second movable frame 44 is obliquely located between the first fixing frame 41 and the second fixing frame 42, and the second movable frame 43 slides along the first fixing frame 41. Two sides of the first movable frame 43 are correspondingly pivotally connected with two sides of the second movable frame 44, such that the first movable frame 43 and second movable frame 44 can be relatively rotated. As shown in FIG. 5 to FIG. 8, both the first movable frame 43 and the second movable frame 44 are obliquely connected between the first fixing frame 41 and the second fixing frame 42, the first movable frame 43 and the second movable frame 44 intersect to form an X-shape, and each center position of the opposite two edges of the first movable frame 43 is correspondingly connected with each center position of the opposite two edges of the second movable frame 44. One side of the second movable frame 44 has a pushing rod 441, and the pushing rod 441 integrally extends from one side of the second movable frame 44 vertically.

One end of the motor 45 is connected with the second fixing frame 42, and the other end of the motor 45 is connected with the pushing rod 441 of the second movable frame 44. The motor 45 pushes the pushing rod 441 of the second movable frame 44, such that the second movable frame 44 slides along the sliding grooves 412 of the first fixing frame 41, and the first movable frame 43 synchronously slides along the sliding grooves 423 of the second fixing frame 42, so as to drive the inner frame 20 to be lifted from the outer frame 30, or the inner frame 20 to be lowered and hidden in the outer frame 30. It can be understood that when the motor 45 pushes the pushing rod 441 of the second movable frame 44 to force the second movable frame 44 to slide along the first fixing frame 41, since the first movable frame 43 and the second movable frame 44 are rotatably connected, the second movable frame 44 also forces the first movable frame 43 to slide along the second fixing frame 42 accordingly. In this way, an angle between the first movable frame 43 and the second movable frame 44 which are cross-connected changes, the first fixing frame 41 is lifted or lowered, a distance between the first fixing frame 41 and the second fixing frame 42 increases or decreases, and the height of the entire lifting mechanism 40 increases or decreases. The lifting mechanism 40 drives the inner frame 20 to be lifted from the outer frame 30 or the inner frame 20 to be lowered and hidden in the outer frame 30. In this way, a height adjustment of the multifunctional lifting table is achieved.

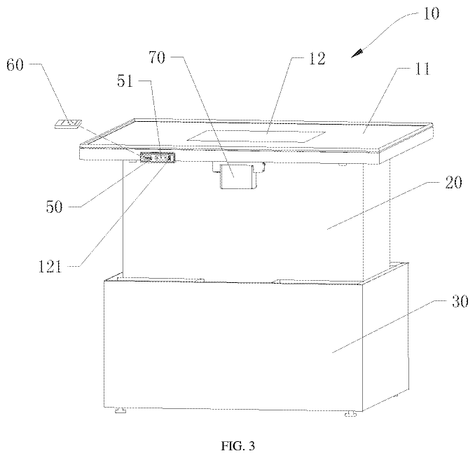

Further, the multifunctional lifting table includes a control panel 50 and a battery box 70, and the control panel 50 is disposed at one side of the tabletop main body 11. As shown in FIG. 1 and FIG. 3, the control panel 50 has a key 51, and the user operates the key 51 to control the lifting mechanism 40, such that the lifting mechanism 40 drives the inner frame 20 to be lifted or lowered. The output interface 121 of the solar panel 12 is disposed at the control panel 50, and four output interfaces 121 are USB interfaces.

The battery box 70 is disposed at one side of the inner frame 20, and the battery box 70 includes a battery and a controller. The control panel 50 is electrically connected with the controller of the battery box 70, the controller of the battery box 70 is electrically connected with the battery, and the controller of the battery box 70 is electrically connected with the lifting mechanism 40. The solar panel 12 is electrically connected with the controller of the battery box 70 to supply power for the lifting mechanism 40. When the inner frame 20 is lowered and hidden in the outer frame 30, the battery box 70 is also hidden in the outer frame 30 accordingly. It can be understood that the lifting mechanism 40 has a plurality of power supply ways, and the lifting mechanism 40 can be power supplied through the solar panel 12, or can be supplied through the battery of the battery box 70. In addition, the battery box 70 itself can also be connected with AC for power supply. This can meet indoor or outdoor usage scenarios of the multifunctional lifting table. For example, when the multifunctional lifting table is used indoors, the battery box 70 can be connected with AC power to supply power; when the multifunctional lifting table is used outdoors, if the weather is fine, the solar panel 12 can be used to generate electricity under sunlight to charge the battery of the battery box 70, electricity stored in the battery is then provided to the lifting mechanism 40; and if it is cloudy and inconvenient to connect AC power, the electricity stored in advance in the battery of the battery box 70 can be used to supply the lifting mechanism 40.

The multifunctional lifting table includes a remote control 60, and the remote control 60 controls the lifting mechanism 40. In this way, the user can also operate the remote control 60 to start the lifting mechanism 40, such that the lifting mechanism 40 drives the inner frame 20 to be lifted or lowered.

It can be understood that the user can select two ways to start the lifting mechanism 40. The user can operate the key 51 on the control panel 50 to control the lifting mechanism 40, and also operate the remote control 60 to remotely control the lifting mechanism 40.

The multifunctional lifting table provided by this invention can be used both indoors and outdoors, and the appearance and the mashup way are unique in design. The solar panel 12 of the tabletop 10 can be used for charging electronic equipment such as the mobile phone, and the function is novel. The solar panel 12 can charge the battery box 70 which is green and environmental.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A multifunctional lifting table, comprising:
a tabletop, comprising a tabletop main body and a solar panel, wherein the solar panel is embedded into the tabletop main body, the solar panel has at least one output interface, and the output interface is located at one side of the tabletop main body;
an inner frame, supporting the tabletop;
an outer frame, having a containing space therein, wherein the inner frame is embedded into the containing space of the outer frame; and
a lifting mechanism, comprising a first fixing frame, a second fixing frame, a first movable frame, a second movable frame, and a motor, wherein outer edges of the first fixing frame are fixed at inner walls of the inner frame, and opposite two sides of the first fixing frame are provided with a sliding groove, respectively; outer edges of the second fixing frame are fixed at inner walls of the outer frame, opposite two sides of the second fixing frame are provided with a sliding groove, respectively, and the two sliding grooves of the second fixing frame are correspondingly parallel to the two sliding grooves of the first fixing frame, respectively; one side of the first movable frame is pivotally connected with the first fixing frame, and the other side of the first movable frame is slidingly connected with the sliding groove of the second fixing frame, such that the first movable frame is obliquely disposed between the first fixing frame and the second fixing frame; one side of the second movable frame is pivotally connected with the second fixing frame, and the other side of the second movable frame is connected with the sliding groove of the first fixing frame, such that the second movable frame is obliquely disposed between the first fixing frame and the second fixing frame, two sides of the first movable frame are pivotally connected with two sides of the second movable frame, respectively, and one side of the second movable frame has a pushing rod; and one end of the motor is connected with the second fixing frame, the other end of the motor is connected with the pushing rod of the second movable frame, and the motor pushes the pushing rod of the second movable frame, such that the second movable frame slides along the sliding grooves of the first fixing frame, and the first movable frame synchronously slides along the sliding grooves of the second fixing frame, such that the inner frame is driven to be lifted from the outer frame or the inner frame is lowered to be hidden in the outer frame.

2. The multifunctional lifting table according to claim 1, wherein the tabletop main body is formed by weaving and winding rattan around pipes.

3. The multifunctional lifting table according to claim 1, wherein the solar panel is a tempered solar glass panel, and a thickness of the solar panel is 5 mm

4. The multifunctional lifting table according to claim 1, wherein the inner frame is formed by weaving and winding rattan around pipes.

5. The multifunctional lifting table according to claim 1, wherein the outer frame is formed by weaving and winding rattan around pipes.

6. The multifunctional lifting table according to claim 1, wherein the multifunctional lifting table comprises a control panel and a battery box, the control panel is disposed at one side of the tabletop main body, the control panel has a key, the battery box comprises a battery and a controller, the control panel is electrically connected with the controller, the controller is electrically connected with the battery, and the controller is electrically connected with the lifting mechanism.

7. The multifunctional lifting table according to claim 6, wherein the solar panel is electrically connected with the controller so as to supply power to the lifting mechanism.

8. The multifunctional lifting table according to claim 1, wherein the multifunctional lifting table comprises a remote control, and the remote control remotely controls the lifting mechanism.

9. The multifunctional lifting table according to claim 1, wherein shapes of the tabletop, the inner frame, and the outer frame are selected from the group consisting of a square shape, a circular shape and a ship shape.
